(19) United States
(12) Patent Application Publication
(10) Pub. No.: US 2004/0199427 A1
(43) Pub. Date: Oct. 7, 2004

(54) Automatic check-out system

(76) Inventor: Franciscus Gerardus Antonius van der Loo, Asten (NL)

Correspondence Address: Ryan A. Schneider, TROUTMAN SANDERS LLP, Bank of America Plaza, 600 Peachtree Street NE, Suite 5200, Atlanta, GA, 30308-2216, US

(21) Appl. No.: 10/755,084

(22) Filed: Jan. 9, 2004

Related U.S. Application Data
(63) Continuation of application No. PCT/NL02/00452, filed on Jul. 10, 2002.

(30) Foreign Application Priority Data
Jul. 11, 2001 (NL) 1018512

(51) Int. Cl. G06F 17/60

(52) U.S. Cl. 705/16

(57) ABSTRACT

An automatic checkout system is described, usable for application in for instance a supermarket, wherein purchases on a conveyer belt provided with a weighing sensor are guided passed barcode reading means, and wherein the identification on the basis of this barcode is checked by weighing the weight of an article and comparing this weight to a weight stored in a memory.

### BENEFIT CLAIM

This application is a continuation of International Application No. PCT/NL02/00452, filed 10 Jul. 2002, which has priority to NL 1018512 filed 11 Jul. 2001.

### FIELD OF THE INVENTION

The present invention relates to a checkout system, usable for application in for instance a supermarket, where often multiple clients are present at the same time, and wherein usually each customer wishes to checkout multiple purchases.

### BACKGROUND OF THE INVENTION

The client has those purchases collected in a shopping basket or shopping cart and arrives at a checkout. Traditionally, this checkout is manned, i.e. staff (a cashier) is present. In the case of conventional checkout systems, this cashier will type the price of each individual item into a cash register. Nowadays, the items are provided with a barcode, and the more modern checkout systems are provided with a barcode reader connected to the cash register; in the case of systems of this type, the cashier will pickup each item, and will move this item through the field of view of the barcode reader, the barcode being directed to the barcode reader. This already is much quicker than inputting the price by hand.

The required presence of operating personnel (cashier) is a disadvantage of the known checkout systems. In a checkout system, personnel costs form a substantial part of the exploitation costs. Further, space must be reserved for the operating personnel, which implies that subsequent checkout systems must be placed at a relatively large mutual distance; conversely, in the case of a certain available space in a location this means a restriction for the total number of checkout systems that can be placed next to each other. It has appeared that customers have a growing need to checkout articles totally on their own and with as little waiting time as possible. This waiting time can be shortened by placing multiple checkout systems. Therefore, checkout systems have been developed which can operate without the necessary presence of a cashier. In the following, such systems will be indicated by the term “automatic checkout system”.

Known automatic checkout systems are based on the presence of a barcode on each article, and therefore comprise barcode reading means as well as transportation means for transporting the articles to be checked out past those reading means, such that the reading means can read the barcode arranged on the articles.

Usually, the barcode reading means comprise at least one scanner, which is adapted to scan the article with a laser beam, and to derive the information stored in the barcode from the intensity variations of the light received back. Since such scanners are commonly known and are usable in the implementation of the present invention, while further the present invention does not relate to improving such scanner, the operation and design of a scanner will not be discussed in further detail here. Suffice it to say that the barcode reading means have a signal output where they offer a reading signal which is representative for the information stored in a recognized barcode. This signal can have the form of a block-shaped signal which represents the black-white parts of the barcode, but can also already have the form of a number, represented by a digital code. In any case, the signal provided is usable for a signal processing unit to look up the required data of the article concerned in an associated data file, including the price. It is even possible that the price itself is coded along in the signal provided. In the following, the output signal given by the barcode reading means will also be indicated by the term “barcode information signal”, and the information comprised in this signal will also be indicated by the term “barcode information”.

It is very important that the articles are recognized by the checkout system quickly and with certainty in a correct way. If an article is recognized incorrectly, an incorrect price is charged. If an article is not recognized, intervention of personnel is still required to judge the article and to feed the correct data into the system.

An important problem in this respect is, for instance, that in practice it can happen that multiple articles are guided past the reading means at the same time, in such a small mutual distance that the reading means consider those articles as one combined article. This problem will hereinafter also be indicated as “cluster problem”. Then, several scenarios are possible. In the first place, it is possible that the barcode reader sees both barcodes, and therefore cannot decide to a single detection. In the second place it is possible that only one barcode is recognized; this can happen if the second barcode is covered by the other article, but also if two identical articles are lying next to each other. In the first example, the system will probably recognize that an error situation occurs; in the second example, it is very well possible that the system does not recognize that an error situation occurs.

Therefore, it is an important aim of the present invention to provide an automatic checkout system which has been improved such that the recognition problems mentioned above are avoided as much as possible, such that the automatic checkout system has a large extent of reliability and operational certainty. More particularly, the present invention aims to provide an automatic checkout system wherein error situations of the above-described type are recognized with an increased level of certainty.

In shops like supermarkets, it is usual that there are articles of which the price is not known per item but per unit weight. Examples of articles of this type are vegetables, fruit, meat products, etc. In order to be able to process articles of this type with the known automatic checkout systems, it is nowadays usual that the articles concerned are weighed in the shop, that a price is calculated, and that a barcode label is printed in which the calculated price is incorporated, which label is to be adhered to the article. Particularly in the case of fresh-articles, these are actions which the consumer must perform, and which take time. It is a further goal of the present invention to reduce this problem, too.

### SUMMARY OF THE INVENTION

According to an important aspect of the present invention, the weight of the scanned articles is always determined also, and the measured weight information is also provided to the signal processing unit of the checkout system. This signal processing unit can use the weight information as check on the barcode information, by comparing the measured weight with an expected weight which is derived from the barcode information. In the case of articles priced per unit weight, it is also possible that the barcode information only relates to the type of article, and possibly to the price per unit weight, and that the price to be charged is determined by the signal processing unit on the basis of the weight measured.

In a further embodiment, a color histogram of the scanned article is made by means of one or two color cameras, and a signal representing the color histogram obtained is provided to the signal processing unit of the checkout system, which uses the color histogram information obtained as alternative for or check on the barcode information. Hereby, an alternative identification possibility is offered for the case that the barcode detection does not lead to an unambiguous identification.

### BRIEF DESCRIPTION OF THE DRAWINGS

The mentioned and other aspects, features and advantages of the present invention will be clarified further by the following discussion of an embodiment of a checkout system according to the present invention while referring to the drawings, in which:

FIG. 1 schematically shows a side view of an article recognition station;

FIG. 2 schematically shows a central processing unit associated with a cash register;

FIG. 3 schematically shows a flow diagram of steps to be performed by the central processing unit;

FIG. 4 shows an adaptation of the flow diagram of FIG. 3 for identification on the basis of a color histogram;

FIG. 5 schematically shows a flow diagram of an operator protocol;

FIG. 6 schematically shows a screen presentation of information to be provided to an operator;

FIG. 7 schematically illustrates an automatic shopping cart checking system;

FIG. 8 schematically shows another embodiment of an article recognition station.

### DETAILED DESCRIPTION OF THE INVENTION

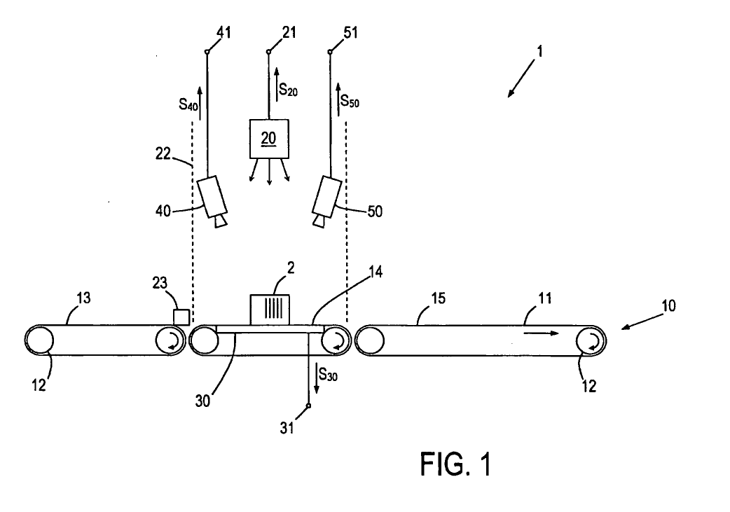

FIG. 1 schematically shows an article recognition station of a checkout system according to the present invention, in the following also indicated as automatic checkout 1. The automatic checkout 1 comprises barcode reading means 20 with a signal output 21, as well as transportation means 10 for transporting articles 2 past the barcode reading means 20. The barcode reading means 20 may comprise one or more barcode scanners, but this is not shown in FIG. 1 for sake of simplicity. By way of alternative, the barcode reading means 20 might for instance comprise an image pickup device, such as for instance a CCD camera, in which case the barcode is then analyzed on the basis of known per se image processing techniques such as will be clear to a person skilled in the art. It is only essential that the barcode reading means 20 at the signal output 21 offer a barcode information signal S₂₀ which is representative for the information stored in a barcode recognized.

Preferably, although not necessarily, the transportation means 10 are of the type comprising an endless conveyer belt 11, such as known per se for checkout systems. Of a mechanism for driving this conveyor belt 11, in FIG. 1 only two drive rollers 12 are shown for sake of simplicity. The displacement direction of the conveyer belt 11 is from left to right in FIG. 1. The items 2 to be scanned are lying on the conveyer belt 11, it being assumed that items are placed on the conveyer belt 11 by the customer in such a way that the barcode (not shown in FIG. 1) is visible. In case an item comprises one barcode only, this barcode must therefore not be facing downwards. This restriction can be lifted if the articles are provided with multiple barcodes on different parts of their surface, or if the barcode reading means are designed to also read a barcode present on the bottom surface.

In FIG. 1, a detection area of the barcode reading means 20 is indicated by reference numeral 22. The arriving of an article is observed by a passage detector 23 (positioned at the left in FIG. 1, at the edge of the detection area 22) associated with the barcode reading means 20. The passage detector can, for instance, be implemented as a light shaft, as will be clear to a person skilled in the art.

The automatic checkout 1 is further provided with weighing means 30. If desired, a separate weighing station might be present, but this requires additional costs and a more complicated construction. Therefore, those weighing means 30 preferably, and as shown, are associated with the transportation means 10. More particularly, the conveyer belt 11 comprises three consecutive sections 13, 14, 15, wherein the middle conveyer belt section 14 is provided with a weighing sensor 30. The left hand conveyer belt section 13 is an input section, and the right hand conveyer belt section 15 is an output section. The middle conveyer belt section 14, which will also be indicated as weighing conveyer belt, conveys with larger speed than the input section 13; in a suitable embodiment, the speeds are about 40 cm/sec (13) and 60 cm/sec (14), respectively. A separation of the subsequent items in the detection area 22 of the barcode reading means 20 is achieved by this speed difference.

In FIG. 1 the central section 14 corresponds to the detection area 22 of the barcode reading means 20, such that the item to be scanned can be weighed simultaneously with the scanning. Although it is possible that the item 2 is kept stationary during weighing, a dynamic weighing (weighing during conveying) is preferred; after all, a higher transfer speed is possible by this, and furthermore an increased wear and tear would occur by the repeated stopping and restarting of the conveyer belt 11.

Since conveyer belts with integrated weighing sensor, suitable for dynamic weighing, are known per se and are commercially available as standard product, the design of the weighing sensor will not be described here in more detail. Suffice it to say that the weighing sensor 30 is provided with a signal output 31, and provides a measuring signal S₃₀ there which is representative for the weight measured momentarily. This measuring signal will hereinafter also be indicated as weight information signal.

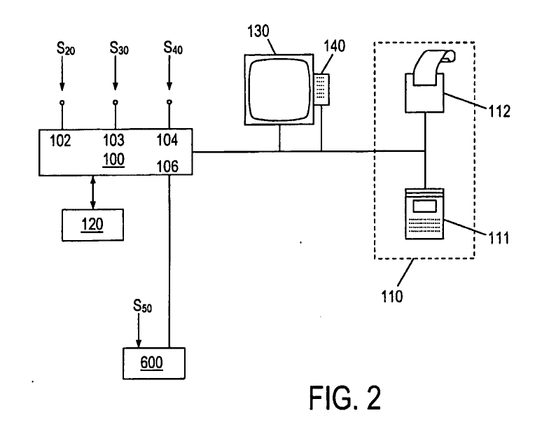

FIG. 2 schematically shows a central processing unit 100, forming part of the automatic checkout. In a preferred embodiment, this central processing unit 100 is implemented by a suitably programmed computer, such as a PC. The central processing unit 100 can for instance also be implemented as a separate, suitably programmed processor. This central processing unit 100 is associated with a cash register 110, which can be provided with a PIN machine 111 and a cash slip printer 112 in the usual way. The cash register 110 can also be provided with a cash point, in order to allow paying with banknotes and/or coins, which is however not shown in FIG. 2 for sake of simplicity. Alternatively, it is also possible that the customer takes the printed cash register slip to a separate, manned checkout station for paying.

Further, the automatic checkout 1 is preferably provided with a display 130, for instance a monitor or an LCD screen, on which for instance information concerning the proceedings of the payment process can be shown to the customer, and on which instructions to the customer can be shown. For the possible input of data and/or commands by the customer, one or more keys can be present, as symbolically indicated at 140.

The central processing unit 100 is provided with a first signal input 102 which is coupled to the signal output 21 of the barcode reading means 20, such that the central processing unit 100 receives the barcode information signal S₂₀. The central processing unit 100 is further provided with a second signal input 103 which is coupled to the signal output 31 of the weighing sensor 30, such that the central processing unit 100 receives the weight information signal S₃₀.

Further, the central processing unit 100 is equipped with or connected to a memory 120 with a file with article information stored therein.

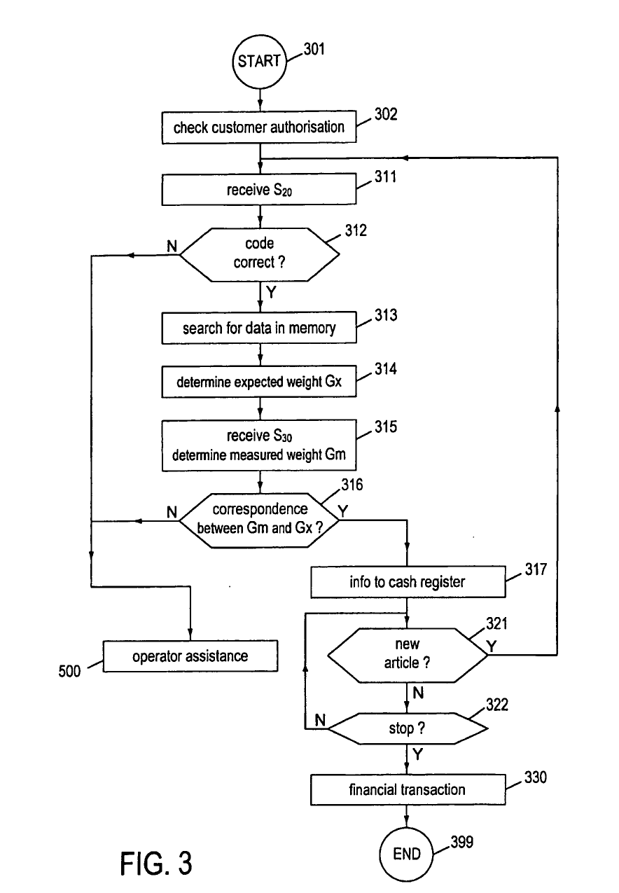

Now, the operation of the checkout system according to the present invention will be explained with reference to FIG. 3, which schematically shows a flow diagram of the steps to be executed by the central processing unit 100 when calculating the price of an article presented. It should be clear that those steps can be the consequence of running a suitable computer program.

A customer arrives at the automatic checkout 1, and starts a payment cycle, for instance by pressing a start button not shown for the sake of simplicity (step 301). If customers must have a special authorization to allow them to use the automatic checkout 1, this authorization is checked (step 302), for which purpose the customer is asked (via display 130), for instance, to insert a customer pass and/or to key a code. If the central processing unit 100 finds the customer authorization to be in order, the conveyer belt 11 is started, and the customer can place his purchases on the input section 13 of the conveyer belt 11. Then, it is intended that the purchases are placed one by one, the relatively fast moving conveyer belt 14 (circa 60 cm/sec) normally assuring a sufficient spatial separation between the consecutive articles 2.

An identification cycle is started when an article passes the passage detector 23. The reading means 20 read the barcode of this article, and generate the barcode information signal S₂₀, which is received by the central processing unit 100 (step 311).

First, the central processing unit 100 investigates the barcode information signal S₂₀, the central processing unit 100 checking whether there is a full and/or valid barcode (step 312).

If the barcode information is incomplete or invalid, the central processing unit 100 cannot process the information and the central processing unit 100 finds an error situation. Then, the central processing unit 100 initiates an alternative identification protocol, or calls the help of a human operator (step 500). Examples of an alternative identification protocol will be discussed later.

If the central processing unit 100 finds that the barcode information corresponds to a complete and valid barcode, the central processing unit 100 looks for the known data of the article concerned in the article information memory 120 (step 313), and the central processing unit 100 determines the expected weight Gx of this article (step 314). Also, the central processing unit 100 receives the weight information signal S₃₀ (step 315), and the measured weight Gm derived there from is compared to the expected weight Gx (step 316). If the measured weight Gm, within predetermined toleration limits, corresponds to the expected weight Gx, i.e. the result of the barcode detection is confirmed by the result of the simultaneous weight measurement, the central processing unit 100 finds that the identification has been performed successfully with certainty. In that case, the central processing unit 100 transfers the necessary information to the cash register 110, namely the price to be charged and preferably also the description for the cash slip (step 317).

If the measured weight deviates from the expected weight with more than the predetermined tolerance, the central processing unit 100 initiates the alternative identification protocol (step 500).

Thus, a large number of cluster problems possibly occurring in practice can be avoided with certainty.

The identification cycle always starts when a new article passes the passage detector 23 (step 321). If there are no more articles, this is indicated by the customer, for instance by pressing a stop button not shown for the sake of simplicity (step 322). Then, the conveyer belt 11 is stopped. This also happens if no articles are detected during a predetermined time (time out).

The customer pays the total amount to be paid, for instance by means of the PIN machine 111 (step 330). With this, the payment cycle is finished (399), and the automatic checkout 1 is ready for a next payment cycle.

Alternatively, the customer can be given a payment slip, and payment is done by a separate payment station. In that case, the automatic checkout is thus ready for a next payment cycle already when the actual payment is still to be performed at said payment station.

It is noted that the present invention primarily concerns the payment of the correct price of the articles to be paid. In a practical implementation of the checkout system, it will of course also be of importance that the price to be paid is paid in a correct manner. It is possible that this is monitored by a supervisor, a person who monitors the correct course of events in several checkout systems. It is also possible that the scanned articles are retained by the checkout system and are only released after payment.

It has been mentioned in the above that the central processing unit 100 determines the expected weight Gx of an article 2. This can be implemented in several ways. Herein, it is sensible to distinguish between genus information and species information. With genus information is meant that the information relates to a certain group of articles with basically mutually equal specifications, such as for instance a packet of sugar: all packets of sugar have the same price, and have in principle the same weight. Yet, the individual weights of the individual articles within this group will show a certain dispersion. With species information is meant that the information relates exclusively to one certain individual article.

In the first place, it is possible that, in the data file which the central processing unit consults when recognizing the article, the weights of the articles are stored also. In that case, the central processing unit 100 can simply determine the expected weight Gx of the article concerned by reading out the weight information stored in the data file. This implementation is especially suitable for genus information.

In the second place, it is possible that, in the barcode itself, information is incorporated relating to the weight of the individual article concerned. In this case, it is a matter of species information. In that case, the central processing unit 100 can simply determine the expected weight Gx of the article by processing the barcode which is read. A limitation of this implementation is that the weight must be measured on application of the barcode, and that the barcode to be written must be adapted to the individual article. However, this solution is specifically suitable for application in the case of fresh-articles like meat products, vegetables, etc., in which case the price beforehand is only known per unit weight, and in which case the price of an individual article is determined by weighing the article. Thus, in this case, the barcode to be written is calculated after weighing the article, and since the weight is known at that moment, that weight can be incorporated in the barcode to be written. Only a relatively simple adaptation of the software is necessary for this in existing apparatus. Further, an important advantage of this implementation is that weighing the individual articles and generating the adapted barcode takes place within the shop where the present checkout system will be arranged, such that the supervisor of the present checkout system (i.e. the shopkeeper concerned) in this implementation does not depend on the cooperation of manufacturers of the articles.

In a variation of this implementation, it is possible that on weighing (and possibly pricing) of the article concerned, only a serial number is coded and incorporated into the barcode, while the combination of serial number and the associated weight is stored in a memory to be consulted by the central processing unit 100. The method with which the central processing unit 100 determines the expected weight then bears a strong resemblance with the method described above: the central processing unit 100 identifies the article by reading the barcode, more specifically the serial number of this article, and the central processing unit 100 reads the weight associated with this serial number from the memory.

The present invention, however, offers the recognition that it is not necessary to weigh this type of articles (such as fresh articles) in the shop, but that one can suffice with a general barcode with an indication of the type as well as the price per unit weight (usually price per kilogram) incorporated therein. In that case, the identification cycle may run in an amended form. The steps 313 and 314 can be skipped, and, after step 315, the central processing unit 100 calculates the article price on the basis of the measured weight Gm and the price per unit weight derived from the barcode, after which process continues with step 317.

In the above, it has been mentioned that the measured weight is derived from the weighing signal S₃₀. If only one single article 2 would lie on the measuring belt 14, the measuring signal is a direct measure for the weight of the article concerned. In general, however, a next article can already reach the weighing belt 14 before the previous article has left the weighing belt 14: in that case, the weighing signal does relate to the total weight of two articles. Depending on the circumstances, there may even be more than two articles lying simultaneously on the weighing belt 14. “Deriving” the measuring weight Gm of a single article then concerns a measuring signal processing, wherein the magnitude of weight steps is taken into account in association with an article reaching and leaving the measuring belt 14; this is also indicated as “sequencing”.

In the above, it has been mentioned that the central processing unit, on comparing the measured weight and the expected weight, takes a predetermined tolerance into account. Information regarding this predetermined tolerance can be communicated to the central processing unit 100 in several ways.

In the first place, it is possible that the central processing unit always uses a fixed tolerance for all articles.

In the second place, it is possible that the allowed tolerance is article-dependent and is stored in the memory 120 to be consulted or is incorporated in the barcode itself, in a manner similar as explained above with reference to the expected weight. In this case, too, distinction can be made between genus information and species information. If the allowed tolerance concerns genus information, both the said article dispersion as the measuring tolerance of the measuring sensor 30 are taken into account in that case. If the allowed tolerance concerns species information, the measuring tolerance of the measuring sensor 30 of the checkout system is taken into account here as well as the measuring tolerance of the measuring sensor of the weighing and pricing station which generates the barcode.

Inputting data relating to weight and tolerance into the memory 120 to be consulted by the central processing unit 100 can be performed by hand, but the checkout system according to the present invention is, in a preferred embodiment, designed to dynamically calculate and store said data in the memory, which is specifically applicable in the case of genus information. In order to use this possibility for inputting a weight and tolerance, for instance when new articles are added to an assortment, a manager switches the checkout system over to a training mode. Subsequently, the manager feeds a large number of “the same” articles through the checkout unit 1, which number can be as desired but preferably is larger than 10. Anyway, articles of different type may be fed in a mixed way in this case. The central processing unit 100 determines the weight of each individual article, and calculates the statistic average of the measured weights as well as the dispersion associated per type. After completion of this measuring cycle, the central processing unit 100 writes the calculated average and the dispersion into the said memory, after which the central processing unit 100 can consult these data in a payment mode.

In an advanced embodiment, the central processing unit 100 calculates the dispersion of the measured weights in the payment mode, too, and the dispersion occurring in practice is written into the said memory by the central processing unit 100.

Then, it can happen that the dispersion occurring in practice deviates from the allowed tolerance inputted in the memory beforehand. In that case, the central processing unit 100 can, in a payment cycle, first compare a measured weight with the allowed tolerance inputted in the memory beforehand, and, if a deviation is found, in a second instance compare the measured weight with the dispersion occurring in practice which has been written into the said memory by the central processing unit 100. If no deviation is found in the comparison in second instant, the central processing unit 100 can still “approve” the article concerned.

Also, the central processing unit 100 can, in case the dispersion occurring in practice deviates from the allowed tolerance inputted beforehand into the memory, generate a warning signal in order for the situation to be investigated by an operator.

It can happen in practice that two (or more) different articles are lying so close to each other that they are measured simultaneously by the weighing sensor 30, and/or that they are interpreted by the automatic checkout 1 as one single article, while the corresponding two (or more) barcodes are correctly read by the reading device 20 and transferred to the barcode input 102 of the sensor processing unit 100. In order to handle this situation, the central processing unit 100 is preferably designed to process all barcodes received in the manner described above; to determine the associated expected weight Gx of each individual article; to add the expected weights concerned to an expected total weight Gxt and to combine the associated tolerances to a total tolerance; and to compare the measured weight Gm with this total weight Gmt in the manner described above, taking the total tolerance into account.

It has appeared that, in general, it is very well possible to identify an article by means of image recognition, such as for instance a color histogram, pattern recognition, optical character reading (OCR), or a combination of said methods. In the following, the example of a color histogram will be elaborated further, but alternatively any of the other methods can always be read. In a manner similar as described before regarding the weight, it is then possible to measure the color histogram of an article presented, and to compare the color histogram with an expected color histogram, as a check after a successful identification on the basis of barcode. This check can be performed in stead of the check on the basis of weight, in which case the weighing sensor 30 can be omitted. The color histogram check can also be performed if the weight check does not lead to an “approval”, in which case a successful color histogram check can still lead to an “approval”. It is also possible that the weight check and the color histogram check are performed both, and that the central processing unit 100 only decides to an “approval” if both checks are successful: in that case, it is a matter of a double check.

However, in a preferred embodiment according to the present invention, the checkout system is designed to perform identification on the basis of color histogram as an alternative identification method when unambiguous identification on the basis of barcode has failed. If the identification on the basis of color histogram succeeds, then the central processing unit 100 proceeds with the weight check as discussed above, and the call for operator assistance can be omitted; the assistance of an operator is only called if the identification on the basis of color histogram fails as well.

Preferably, and as also illustrated in FIG. 1, to this end, the automatic checkout 1 according to the present invention is provided with color histogram generating means 40 which offer a signal S₄₀ at an output 41 which is representative for the color histogram, and the central processing unit 100 is provided with a third input 104 which is coupled to this signal output 41. In the following, said signal S₄₀ will also be indicated as color histogram signal, and the information contained therein will also be indicated as color histogram information.

Color histogram generating means are known per se. For instance, they comprise a color CCD camera as well as means for counting how often a certain color occurs in the image taken (i.e.: how many pixels have this specific color). The technique of making a color histogram per se needs therefore not to be explained in more detail here.

According to the present invention, the color histogram generating means 40 comprise at least one and preferably at least two image pickup members (such as for instance two color CCD cameras), arranged on opposite sides of the weighing conveyer belt 14, in order to observe an article to be examined from two or more directions, and the color histogram generating means 40 are adapted to generate as color histogram signal S₄₀ a combination of the two (or more) individual color histogram signals of the two (or more) individual image pickup members. Advantageously, this combination is a simple arrangement.

In a possible variation, the cameras provide two complete images to the central processing unit 100, and the central processing unit 100 itself is programmed for calculating the color histogram from the image signals presented.

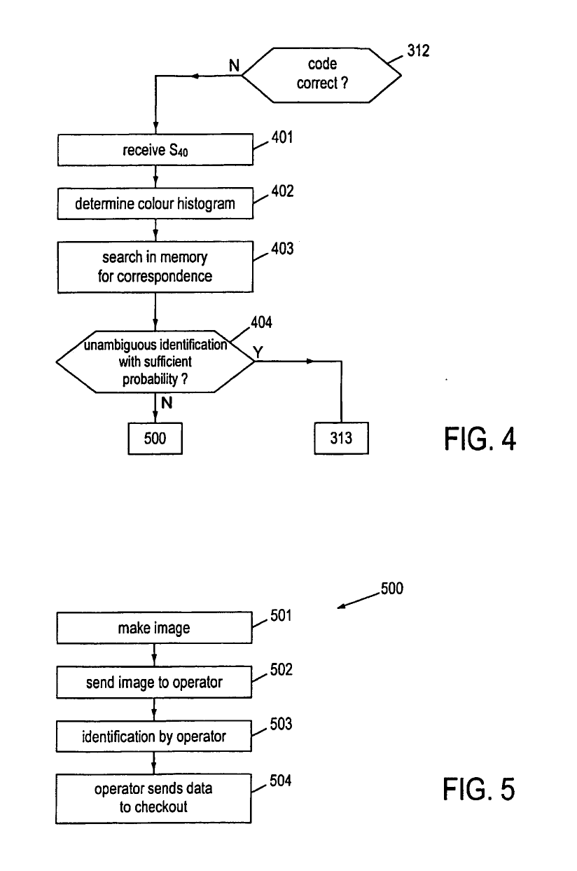

Now, with reference to FIG. 4, the identification on the basis of color histogram will be explained in more detail.

If, in step 312, it is decided that the barcode information is incomplete or invalid, the central processing unit 100 starts to check the color histogram. First, the central processing unit 100 receives (step 401) the image signals S₄₀ of the image pickup units (cameras). These image signals may already be a coded color histogram, but also a coded original image recording, in which case the central processing unit 100 determines the color histogram (step 402). Then, the central processing unit 100 consults the memory 120, and compares the color histograms stored therein with the measured color histogram of the presented article (step 403). If a color histogram is found in the memory 120 which corresponds to the measured color histogram of the presented article in a sufficient extend, the central processing unit 100 decides that identification has taken place with a sufficient extent of certainty, and the central processing unit 100 continues with step 313. If not, the assistance of an operator is called (500) as second alternative identification method.

Now, with reference to FIG. 5, an example will be described of an operator protocol 500 which is set in operation by the central processing unit 100 if the identification of an article fails or the measured weight does not correspond to the expected weight.

The basic idea behind the second alternative identification method proposed by the present invention is that human assistance must be called if automatic identification fails. Of course, it is then possible to generate an alert signal in order to attract the attention of a patrolling checkout assistant, who then physically goes to the checkout concerned in order to assess the situation. However, this takes relatively much time, and furthermore has the disadvantage that calling this checkout assistant is observed by bystanders which may be experienced by the paying customer as being indiscrete.

Therefore, preferably, the assistance is called of an operator located at a distance by sending a camera image of the article concerned to a monitor checked by this operator. To this end, preferably, and as illustrated in FIG. 1, the automatic checkout proposed by the present invention is provided with an image pickup member such as a color camera 50, with an output 51 for generating (step 501) an image signal S₅₀ which is representative for an image taken from an article. This output 51 is coupled to the central processing unit 100, which transfers the image signal S₅₀ to an operator station 600 (step 502) if the central processing unit 100 finds that automatic identification of the article concerned fails. On the basis of the received image, the operator performs an identification (step 503), and the operator sends the required data to the central processing unit 100 (step 504). To this end, the central processing unit 100 is provided with a fourth input 106 which is coupled to the operator station 600 for receiving the information provided by the operator.

The data sent to the central processing unit 100 by the operator may directly be the price information and possibly a description for a checkout slip. In that case the central processing unit 100 can proceed at step 317. However, it is also possible that the data sent to the central processing unit 100 by the operator are comprised of barcodes, and are processed by the central processing unit 100 in the same manner as the barcodes received from the barcode scanners; in that case, the central processing unit 100 can proceed at step 313.

In principle, separate cameras can be present for generating a color histogram on the one hand and for providing an image recording for the operator station 600 on the other hand. There is, however, no necessity for this. In a preferred embodiment, the automatic checkout 1 has two cameras arranged on opposite sides of the conveyer belt 11, which make image recordings from the presented articles which are used both for determining a color histogram by the central processing unit 100 and for effecting a human identification by the operator station 600, such that these cameras perform both the function of the means 40 and the function of the means 50.

In principle, it is possible that the image pickup member 50 takes an image only if identification has failed. In practice, however, it is more convenient that an image recording is always made by the image pickup member 50 from each presented article 2 (i.e.: two recordings by the two cameras arranged on opposite sides of the conveyer belt 11), and that the central processing unit 100 decides whether or not these recordings are used for calculating a color histogram and/or transfer to the operator station 600.

The operator station 600 can be arranged at a distance from the automatic checkout 1 within the same building, but if desired it is possible that the operator station 600 is located at a larger distance and is part of a center to which multiple shops are connected, and that data communication takes place via a communication network, for instance a computer network such as internet, an intranet, etc.

The operator station 600 may be associated with multiple automatic checkouts, such that a single operator can assist in article detection for multiple checkouts.

Also, a pool of multiple operator stations 600 may be present, and the image signal is transferred to any of the operator stations who are free at that moment.

In a simple embodiment, a operator station is only provided with a monitor onto which the observed article image is projected, and a keyboard or other input device with which the operator can key-in a price and possibly a description, and/or an article code. Then, the operator himself determines the price, for instance by consulting an article list.

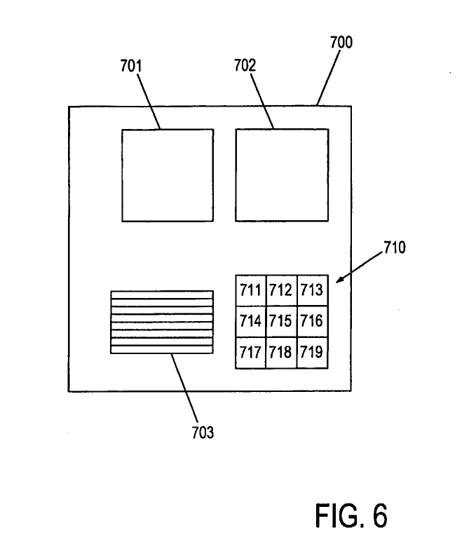

FIG. 6 shows an example of a screen presentation for an operator in a more advanced embodiment of an operator station. Not only the two images 701 and 702 of the article are projected onto the screen 700, but also some suggestions for possible identifications, for instance by a suitably programmed computer. These suggestions may be projected in the form of a written list 703, and/or in the form of a series of exemplary pictures, which are stored in a stock memory associated with the checkout system. In FIG. 6, a mosaic 710 with nine exemplary pictures 711-719 is shown in the lower right quadrant of the image screen 700.

The order of the suggestions in the list 703 and the mosaic 710 preferably corresponds to the probability that the suggestion concerned is correct. In calculating this probability, the computer can base itself on the image received from the article concerned even if this is incomplete information. For instance, it is possible that a barcode fragment has been recognized; in that case, the computer will first suggest those articles whose barcodes comprise this barcode fragment, always taking account of the measured weights. Also, it is for instance possible that the computer compares the color histogram with the color histograms of the pictures stored in its memory, and basis the level of probability on the extend of similarity between measured color histogram and color histogram taken from memory.

In this way, not only will it be easier for an operator to recognize the article displayed, but also it is easier for the operator to communicate his identification to the central processing unit 100 by, in a manner such as commonly known in the case of computer systems, moving a pointer over the monitor screen 700 by means of a device such as a computer mouse, and clicking on the desired text or the desired picture.

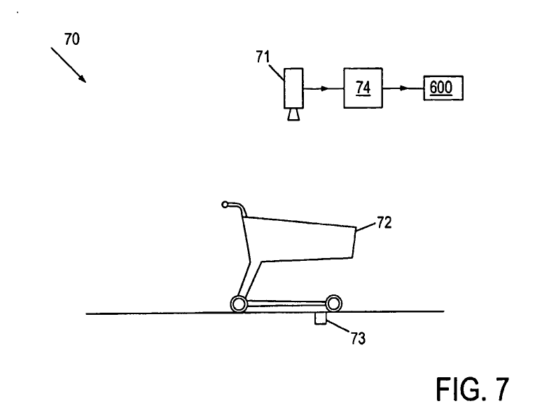

It may happen in practice that a customer forgets to place an article from the shopping cart onto the conveyer belt 13, such that this article is not detected and is not paid. In order to counteract this, a further preferred embodiment of the checkout system according to the present invention is provided with an shopping cart checking system 70 which checks whether the shopping carts are completely empty. According to an important aspect of the present invention, this check takes place on the basis of image processing. To this end, as schematically illustrated in FIG. 7, the automatic checkout 1 is provided with a further camera 71, which is arranged above a path where the shopping carts 72 must pass the automatic checkout 1. A suitable cart detector 73, which comprises for instance an induction loop, detects the presence of a shopping cart 72, and generates a trigger signal for the camera 71, which takes a picture of the shopping cart. This picture is transferred to an image processing unit 74, which assesses the picture taken and compares this picture with an image of an empty shopping cart stored beforehand in a memory. In case this comparison results in significant differences which are indicative for a non-empty shopping cart, the image processing unit 74 generates a warning signal, for instance to operator station 600 already mentioned.

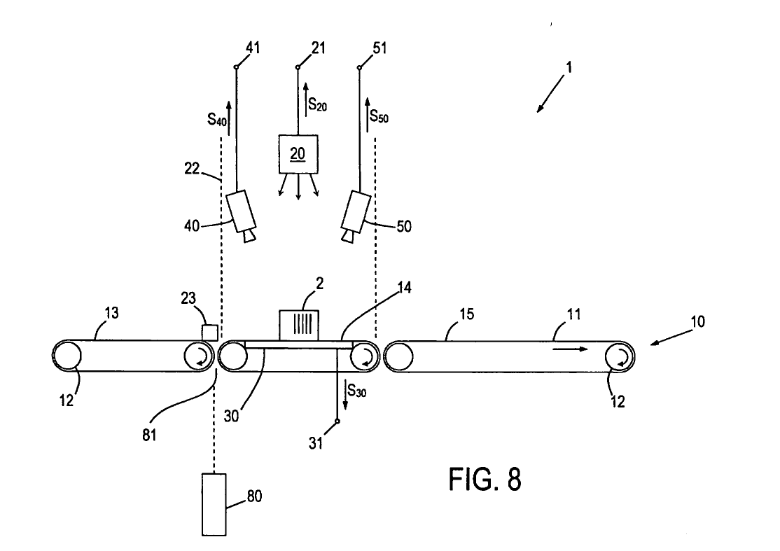

In the above, with reference to FIG. 1, it has been described that known per se barcode reading means may be arranged close to a conveyer belt 11, in which case all surfaces of the article can be seen by the barcode reading means, except the underside. In a special preferred embodiment, a line scanner 80 is provided, arranged under a gap 81 between two adjacent conveyer belts, such as the conveyer belts 13 and 14, as illustrated in FIG. 8. The line scanner is associated with suitable, and suitably positioned, illumination means, as will be clear to a person skilled in the art. Thanks to such an arrangement, it is possible to also collect data from the underside of the transported articles.

Line scanners are known per se apparatuses, so that a discussion of the design and operation thereof is not necessary. Suffice it to say that a line scanner is capable of generating a signal which is comparable to a single horizontal line of a video image. The signals generated by the line scanner are processed by a signal processing device, which may be associated with or identical to the said processing unit 100.

While an article passes, the line scanner provides subsequent line images. The subsequent line images thus correspond to a line-by-line scanning of an article, comparable to an image generated by a 2D camera. Therefore, the subsequent line images can be processed by means of special or standard image processing software, in a manner comparable with the processing of a “normal” video image. However, it is also possible to use image processing software which is specifically intended for processing subsequent individual line images.

In this respect, it is noted that the line frequency of the line camera, i.e. the number of line images per second, may be equal to the standard line frequency of a standard video image, for instance 25 Hz, but this is not necessary. In a possible embodiment, taking a line image is triggered by said signal processing device or the said processing unit 100, with a repetition frequency determined by this device, which may be higher or lower than the standard line frequency.

From the line images provided, several kinds of information can be derived by means of image processing software. For a start, the presence or absence of an article can be established, such that the line scanner 80 can perform the function of the said passage detector 23. Then, a separate passage detector is no longer necessary.

Further, it is possible that a barcode is recognized in the obtained image information. Among else, this means that the customer has no restrictions anymore when placing the articles to be paid: after all, the barcode may now also be facing downwards. The recognized barcode can be processed by standard barcode translation software, in order to derive the character series represented by the barcode, and on the basis of this, the identity and price of the article concerned can be looked up in a database, in the same manner as described before. In a possible embodiment, the barcode information is obtained exclusively by means of the line camera. This offers the advantage that it is no longer necessary to arrange a system of barcode scanners in a tunnel construction, such that the costs of the entire installation may be lower, but this involves the restriction in use that the customer must place the articles on the belt with the barcode facing downwards.

Further, it is possible that a color histogram is derived from the obtained image information, which information can be used in the same manner as described above.

Further, it is possible that in the obtained image information written characters (letters and ciphers) are recognized, and that this information is used to recognize the articles.

Further, it is possible that in the obtained image information certain characteristic image parts are recognized, such as for instance a logo of a manufacturer, or a picture of a product, and that this information is used to recognize the articles.

Further, it is possible that shape features of the article are derived from the obtained image information, and that this information is used to recognize the articles. For instance, it is possible to derive the length of the article from the number of lines where a part of the article is imaged, in conjunction to the used line frequency and the velocity of the article, which corresponds to the velocity of the conveyer belts. Further, it is possible to determine the width of the article part concerned per line, and to combine the data of all lines to a contour of the article. All these data can be used in recognizing the articles.

In a manner similar as described above, it is possible to arrange a line camera besides the transporting trajectory of the articles, in order to thus obtain line images of a side of the articles, which can be processed in the same way as described above. One may suffice with one single line camera, or two line cameras opposite each other. In this way, it becomes possible to determine a side view contour of the articles, which can be combined with the bottom view contour into a 3D contour and/or a volume contents, which data may be usable in recognizing the articles.

In a further elaboration, multiple line cameras may be arranged besides the transport trajectory of the articles, which “see” the articles from front, from behind and/or from above, respectively. If desired, they can thus entirely replace the said barcode scanners.

It will be clear to a person skilled in the art that the present invention is not limited to the examples discussed in the above, but that alternatives, amendments, modifications and variations are possible within the scope of the invention as defined in the appending claims.

In the above, with reference to FIG. 3, the course of an identification cycle has been described and it has been noted that this cycle is run for each article offered. In fact, it is more precise to say that for each article offered such a cycle is run. Each individual cycle starts with receiving the barcode information signal S₂₀ (step 311) and each individual cycle ends with transferring the article information to the cash register (step 317). However, the individual cycles need not all have the same duration. Some articles will be identified quickly, in the case of other article it takes somewhat longer, and sometimes even the assistance of an operator is needed. In principle, it is possible that a new identification cycle only starts after successfully completing the previous identification cycle, but the consequence may be that the conveyer belt 11 regularly must be kept stationary, especially when the assistance of an operator is needed. According to the present invention, the transport by means of the conveying belt takes place continuously, and a new identification cycle can start independently from the fact whether or not the previous identification cycle has finished. Then, in practice, multiple identification cycles may usually run in parallel, and the order of recognition may deviate from the order of passage.

Furthermore, it may be noted in this respect that an identification cycle may also be started if the weight residue is larger than a predetermined threshold. Herein, with weight residue is meant the difference between on the one hand the measured cluster weight and on the other hand the total weight of the articles already identified within this cluster.

Further, it is possible that operational parameters of an automatic checkout are transferred to the operator, so that it is possible to intervene in an early stage if symptoms occur which indicate a possible future failure of a part. An example of such operational parameters is for instance the diode current of the lasers applied in the barcode scanners.

In the preferred embodiments discussed above, the articles are moved past one or more fixedly positioned scanners by means of a conveyer belt which is provided with integrated weighing means. Within the scope of the present invention, a simpler version of the checkout system is possible, wherein the barcodes are read by a hand-scanner to be operated by the customer, and wherein a separate weighing station is present for the weight check.

What is claimed is:

1. Method for paying articles by means of an automatic checkout, comprising the steps of:
storing information regarding a measurable parameter of the articles to be paid in a memory beforehand;
in a payment cycle, performing a first identification step regarding an article;
preferably simultaneously, measuring the said measurable parameter of the article concerned;
looking up an expected value of the said measurable parameter of the identified article in the said memory;
comparing the measured value to the expected value;
and finding that the presented article has been correctly identified if the measured value appears to correspond to the expected value within predetermined tolerance limits.

2. Method according to claim 1, wherein the said measurable parameter is the weight.

3. Method according to claim 1, wherein the said measurable parameter is a color histogram.

4. Method according to claim 1, wherein said articles are provided with a barcode, and wherein the said first identification step comprises reading the barcode.

5. Method according to claim 4, wherein the barcode is read by a hand-scanner, or is moved by hand past a fixed scanner.

6. Method according to claim 4, wherein an article is transported past barcode reading means by means of transporting means, and wherein the article concerned is identified on the basis of the barcode read by the barcode reading means.

7. Method according to claim 1, wherein an alternative identification step is performed on the basis of image recognition if identification by means of the said first identification step does not succeed or does not succeed completely.

8. Method according to claim 7,
wherein information regarding the color histograms of the articles to be charged is stored beforehand in the memory;
wherein said alternative identification step regards an identification on the basis of a color histogram;
and wherein, after a successful alternative identification step, one proceeds with checking on the basis of said measurable parameter.

9. Method according to claim 1, wherein, if identification fails or the check on the basis of said measurable parameter does not lead to correspondence with the identification result, an image of the article concerned, obtained by an image pickup device such as a camera, is sent to an operator station, where this image is studied by an operator, who subsequently sends the required information to the automatic checkout.

10. Checkout system, comprising:
barcode reading means, designed for scanning an article located in an detection area, reading a barcode located thereon, and generating a barcode information signal which is representative for the information stored in a read barcode or barcode fragment;
a measuring device for measuring a predetermined measurable parameter of the articles, and for generating a measuring signal which is representative for the measured parameter;
a central processing unit, of which a first input is coupled to a signal output of the barcode reading means for receiving the barcode information signal, and of which a second input is coupled to a signal output of the measuring device for receiving the measuring signal;
wherein the central processing unit is designed to derive an identification of the article concerned from the received barcode information signal; to determine an expected value of said parameter of the identified article; to derive a measuring value of said parameter from the received measuring signal; to compare this measuring value to the expected value; and to approve the identification if this measuring value corresponds to the expected value within predetermined tolerance limits.

11. Checkout system according to claim 10, wherein the measuring device comprises a weighing sensor.

12. Checkout system according to claim 10, further provided with transporting means for transporting articles past the barcode reading means.

13. Checkout system according to claim 12, wherein the transporting means comprise a conveyer belt which comprises at least one weighing belt section with an integrated weighing sensor.

14. Checkout system according to claim 13, wherein the transporting means with integrated weighing sensor are designed to perform dynamic weighing.

15. Checkout system according to claim 13, wherein the weighing belt section with integrated weighing sensor is located within the detection area of the barcode reading means.

16. Checkout system according to claim 13, wherein the conveyer belt comprises an input section arranged upstream of the weighing belt section, of which the transporting velocity is smaller than the transporting speed of the weighing belt section.

17. Checkout system according to claim 10, wherein the central processing unit is adapted to determine the said expected value of said parameter on the basis of the received barcode information signal.

18. Checkout system according to claim 10, further comprising a memory associated with the central processing unit, in which the expected value of the said measurable parameter regarding the articles is stored;
wherein the central processing unit is designed to determine the said expected value of said parameter by consulting the memory.

19. Checkout system according to claim 10, wherein the central processing unit, if the barcode information of a certain article is representative for a price per unit weight, is designed to determine the price for this article by multiplying said price per weight by the weight derived from the weighing signal.

20. Checkout system according to claim 10, further comprising:
image processing means for processing an image of an article located in a detection area of the barcode reading means;
wherein the central processing unit, if identification on the basis of the barcode fails, is designed to identify the article concerned in an alternative identification procedure by image processing.

21. Checkout system according to claim 20, wherein said image processing means comprise means for calculating a color histogram of an article;
wherein a memory associated with the central processing unit is provided, in which is stored information regarding the corresponding color histogram regarding the articles;
and wherein the central processing unit, if identification on the basis of the barcode fails, is designed to compare the calculated color histogram to the information stored in the memory in order to thus identify the presented article.

22. Checkout system according to claim 21, comprising at least one image pickup device for generating an image signal which represents an image of an article located in the detection area of the barcode reading means, and wherein the central processing unit is provided with a third input coupled to an output of the image pickup device for receiving the image signal.

23. Checkout system according to claim 10, further comprising:
at least one image pickup device for generating an image signal which represents an image of an article located in the detection area of the barcode reading means;
at least one operator station, which is located at a distance from the automatic checkout but is capable of communicating with the automatic checkout via a communication network;
wherein the central processing unit, if identification of an article fails or the check on the basis of said measurable parameter does not lead to correspondence to the identification result, is designed to send the image signal to the operator station, and to receive information generated by an operator after studying the image.

24. Checkout system according to claim 23, wherein the operator station is provided with at least one screen, and is designed to project the image onto this screen;
and wherein the operator station is further designed to project onto this screen a series of suggestions of probable articles, in the form of a written list and/or in the form of a series of predetermined pictures stored in a memory, wherein the series is preferably projected in an order of decreasing probability;
and wherein the operator station is preferably designed to allow the operator to input his decision by clicking on a projected suggestion.

25. Checkout system according to claim 10, further comprising a shopping cart checking system operating on the basis of image processing.

26. Checkout system according to claim 25, wherein the shopping cart checking system comprises:
a camera, arranged above a path where shopping carts must pass the automatic checkout;
an image processing unit coupled to the camera;
a memory associated with the image processing unit with at least one reference image of an empty shopping cart stored therein;
an cart detector coupled to the camera for detecting the presence of a shopping cart, designed for generating a trigger signal for the camera or the image processing unit;
wherein the image processing unit is designed for receiving an image made by the camera in response to the trigger signal generated by the cart detector, and for comparing the received image with at least one of the reference images stored in the memory.

27. Checkout system according to claim 10, wherein said barcode reading means comprise at least one line camera.

28. Checkout system according to claim 27, wherein the line camera is arranged below a transporting trajectory of the articles, for instance below a gap between two adjacent conveyer belts.

29. Checkout system according to claim 27, wherein a signal processing device is designed to:
a) determine the presence/absence of an article;
and/or b) recognize a barcode;
and/or c) derive a color histogram;
and/or d) recognize written characters;
and/or e) recognize characteristic image parts;
and/or f) derive shape features of an article, such as:
the length of the article;
a contour of the article from the signals provided by the line camera.

30. Checkout system according to claim 27, wherein at least one line camera arranged besides the transporting trajectory of the article is provided, wherein a signal processing device is preferably designed to determine a 3D contour and/or a volume contents from the signal provided by the line cameras.
